(19) United States
(12) Patent Application Publication
(10) Pub. No.: US 2024/0338226 A1
(43) Pub. Date: Oct. 10, 2024

(54) AUTOMATED ADDITION OF DEVICE IDENTIFICATION INFORMATION INTO PRE-PROVISIONING SYSTEM

(71) Applicant: Insight Direct USA, Inc., Chandler, AZ (US)

(72) Inventors: John Christopher Broad, Wake Forest, NC (US); Joseph Raymond Flynn, Hackettstown, NJ (US); Genesis Roman Rodriguez, Jersey City, NJ (US)

(21) Appl. No.: 18/204,473

(22) Filed: Jun. 1, 2023

Related U.S. Application Data
(60) Provisional application No. 63/457,648, filed on Apr. 6, 2023.

(51) Int. Cl. G06F 9/445

(52) U.S. Cl. CPC G06F 9/4451

(57) ABSTRACT

A method of pre-provisioning a computer hardware device for a client can include receiving an order for the device from the client, identifying whether the client has a pre-provisioning profile, in response to the client having a pre-provisioning profile, extracting device identification information for the device, configuring (by a computer processor) the device identification information into reformatted device identification information suitable for upload to a pre-provisioning center with the pre-provisioning center having the pre-provisioning profile for the client that designates a provisioning configuration for the device and configured to provision the device in response to a start-up prompt by the device, and uploading (by the computer processor), in response to the configurating of the device identification information into reformatted device identification information, the reformatted device identification information to the pre-provisioning center to link the device with the provisioning configuration of the client.

### CROSS-REFERENCE TO RELATED APPLICATION

The present application claims priority to U.S. provisional patent application Ser. No. 63/457,648 by J. Broad, filed Apr. 6, 2023 and entitled “AUTOMATED ADDITION OF DEVICE IDENTIFICATION INFORMATION INTO PRE-PROVISIONING SYSTEM.”

### FIELD OF THE INVENTION

The disclosure relates generally to pre-provisioning computer hardware devices and, more specifically, to the automated collection of device identification information for use in associating the device with a pre-provisioning configuration designated by the device owner in an online pre-provisioning center.

### BACKGROUND

When an individual and/or company (hereinafter, collectively, a “client”) orders/purchases a computer hardware device, such as a computer processor, the device often arrives to the client with no client-specific software installed and/or user configurations set up on the device. To configure the device for the client's needs and/or preferences (called provisioning the device), the client must either select, download, and install the software and/or take multiple, complex steps to configure the client's preferences on the device, or the device must first be sent to a provisioning vendor who provisions the device before sending the device to the client. These options are time consuming and may require numerous actions taken on the physical device during provisioning before the client can use the device as intended.

### SUMMARY

A method of pre-provisioning a computer hardware device for a client can include receiving an order for the device from the client, identifying whether the client has a pre-provisioning profile, in response to the client having a pre-provisioning profile, extracting device identification information for the device, configuring (by a computer processor) the device identification information into reformatted device identification information suitable for upload to a pre-provisioning center with the pre-provisioning center having the pre-provisioning profile for the client that designates a provisioning configuration for the device and configured to provision the device in response to a start-up prompt by the device, and uploading (by the computer processor), in response to the configurating of the device identification information into reformatted device identification information, the reformatted device identification information to the pre-provisioning center to link the device with the provisioning configuration of the client.

A system for pre-provisioning preparation for a computer hardware device for a client can include an order reception module configured to receive an order for the device from the client, an identification module that reviews the order by the client and determines whether the client has a pre-provisioning profile, an extraction module in communication with the order reception module and configured to, in response to the identification module determining that the client has a pre-provisioning profile, extract device identification information for the device, a configuration module in communication with the extraction module and configured to reformat the device identification information into reformatted device identification information suitable for upload to a pre-provisioning center having the pre-provisioning profile for the client that designates a provisioning configuration for the device and being configured to provision the device in response to a start-up prompt by the device, and an upload module in communication with the configuration module and configured to upload, in response to the configurating of the device identification information into reformatted device identification information, the reformatted device identification information to the pre-provisioning center to link the device with the provisioning configuration of the client.

### BRIEF DESCRIPTION OF THE DRAWINGS

FIG. 1A is an example of a schematic of a system for pre-provisioning and provisioning a computer hardware device.

FIG. 1B an example of a schematic of a pre-provisioning preparation system for use within the system of FIG. 1A.

FIG. 2 is an example flow chart of a pre-provisioning preparation process performed by the system in FIGS. 1A and 1B.

While the above-identified figures set forth one or more examples of the present disclosure, other examples/embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and examples of the present invention may include features and components not specifically shown in the drawings.

### DETAILED DESCRIPTION

Systems and related methods are disclosed herein for use in collecting preparatory information and pre-provisioning a computer hardware device purchased (e.g., ordered) by an individual, company, or another entity (hereinafter, a “client”) with software and/or configurations as specified by that client dependent upon client needs and/or preferences. As a part of these processes, the systems can receive an order for the device as placed by the client, identify that the client is one that has a pre-provisioning profile detailing the provisioning configuration for the device (e.g., by reviewing a record that includes a list of all clients that have a pre-provisioning profile), associate (e.g., link) the device with the client, and extract device identification information from the device. The device identification information can then be configured into reformatted device identification information that is suitable to be uploaded to (e.g., places the information in a format that is able to be accepted by) a pre-provisioning center that can include the pre-provisioning profile and the provisioning configuration as specified by the client. The systems can automatically extract the device identification information, configure the information into reformatted device identification information, and upload the reformatted device identification information to the pre-provisioning center. For example, the system can upload the reformatted device identification information in response to the configuring of the device identification information into reformatted device identification information. The systems can link the reformatted device identification information with a device profile so that, when the device is deployed (i.e., powered on and connected to the internet) by the client, the pre-provisioning center connects to the device and provisions the device with the provisioning configuration specified in the pre-provisioning center. Without the systems uploading the reformatted device identification information for the device to the pre-provisioning center, the client may have to take multiple, complex steps to connect to the pre-provisioning center, notify the pre-provisioning center of the particular device that needs to be provisioned, and begin the provisioning process.

In this disclosure, “provisioning” includes having a third party, such as a vendor or outside company (e.g., not the client), set up the device with client-specific software, layouts, applications, configurations, etc. (hereinafter referred to as “software and/or configurations”) so that the client does not need to set up the device itself when the device is deployed. Additionally, in this disclosure, “pre-provisioning” includes selecting the client-specific software, layouts, applications, configurations, etc. before the device is deployed so that, upon deployment, the device can be provisioned soon thereafter without the need for too many additional actions.

The systems and related processes can include various additional features, such as the ability to identify, after the order from the client has been received, whether the client has a pre-provisioning profile (e.g., by reviewing a record that includes a list of clients that have a pre-provisioning profile) and, if so, continue with the pre-provisioning preparation process. Also, the systems and related processes can have the ability to examine the extracted device identification information and/or the reformatted device identification information and, in response to the information being in a configuration that cannot be accepted by the pre-provisioning center upon upload, prompt an alert to a troubleshooting system and/or automatically reconfigure the information into an acceptable format. The systems and related processes can also create a device profile (for the device ordered by the client) having the reformatted device identification information. The device profile can be in the pre-provisioning center, and the processes can further associate that device profile with the client pre-provisioning profile. The systems can work in conjunction with a hardware vendor (or can include all the responsibilities and/or functionality of a hardware vendor) to receive the order for the device from the client, associate the device with the client (e.g., find the device within its inventory), and extract the device identification information before the device is delivered to the client. The various capabilities, functions, configurations, and advantages of the disclosed systems and processes will be realized by reviewing this disclosure.

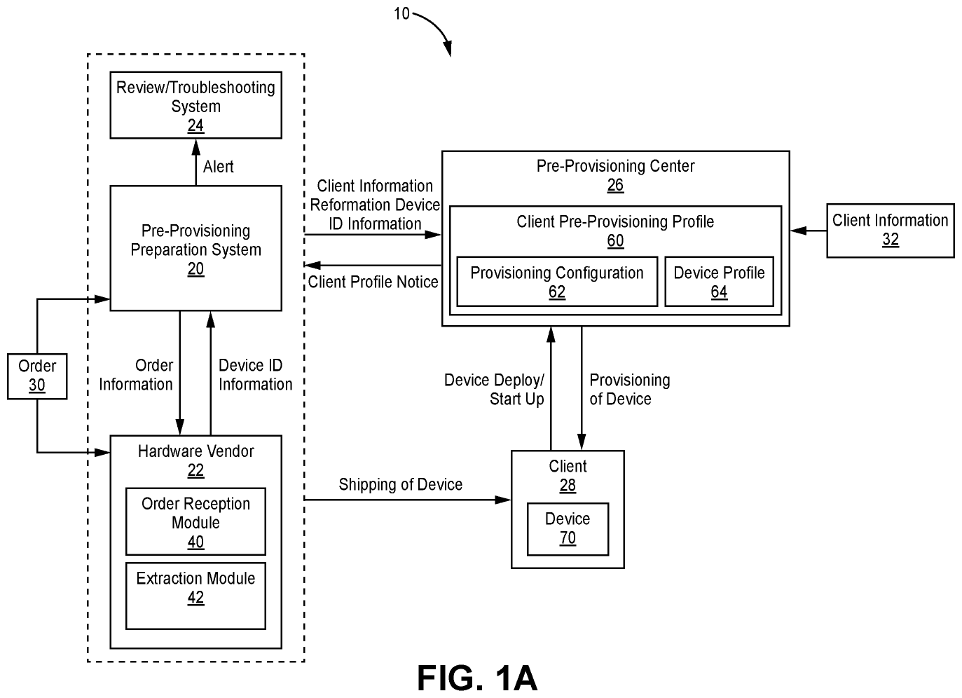

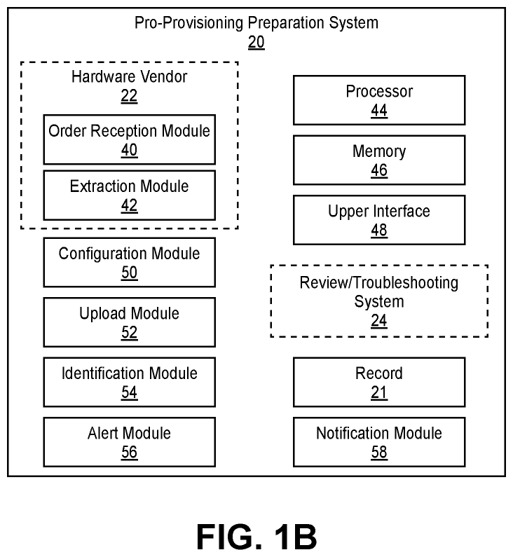

FIG. 1A is an example of a schematic of the system for pre-provisioning and provisioning a computer hardware device, while FIG. 1B is an example of a schematic of a pre-provisioning preparation system. FIGS. 1A and 1B are described together. Pre-provisioning and provisioning system 10 (also referred to herein as “provisioning system 10”) includes pre-provisioning preparation system 20 (also referred to herein as “preparation system 20”), hardware vendor 22, troubleshooting system 24, pre-provisioning center 26, and client 28. Order 30 and client information 32 are received by provisioning system 10. Hardware vendor 22 can include order reception module 40 and extraction module 42, and, as shown in FIG. 1B, preparation system 20 can be an extended system that includes hardware vendor 22 and/or review or troubleshooting system 24 (also referred to herein as (troubleshooting system 24″). Pre-provisioning preparation system 20 can also include record 21, processor 44, memory 46, user interface 48, configuration module 50, upload module 52, identification module 54, alert module 56, notification module 58 as well as other components not expressly disclosed herein. Pre-provisioning center 26 can include client pre-provisioning profile 60 having provisioning configuration 62 and/or device profile 64, and client 28 can be delivered/provided with computer hardware device 70 so as to have physical possession and/or control over device 70.

Pre-provisioning and provision system 10, as well as pre-provisioning preparation system 20, can include other components not expressly disclosed herein and/or can have other capabilities, functions, and/or configurations than those disclosed herein and shown in FIGS. 1A and 1B. Additionally, provisioning system 10 and/or preparation system 20 can each or collectively be a discrete assembly or be formed by one or more elements capable of individually or collectively implementing the functionalities described herein. In some examples, provisioning system 10 and/or preparation system 20 can be implemented as a plurality of discrete circuitry subassemblies. In some examples, one or all components of pre-provisioning and provisioning system 10 and/or pre-provisioning preparation system 20 can include or be implemented at least in part as a smartphone or tablet, among other options. In some examples, one or all components of pre-provisioning and provisioning system 10 and/or pre-provisioning preparation system 20 can include and/or be implemented as downloadable software in the form of a mobile application. The mobile application can be implemented on a computing device, such as a personal computer, tablet, or smartphone, among other suitable devices. One or all components of provisioning system 10 and/or preparation system 20 can be considered to form a single computing device even when distributed across multiple component computing devices.

Any components of pre-provisioning and provisioning system 10 and/or pre-provisioning preparation system 20 can use a rules-based engine/program to establish and refine functions/techniques for performing the processes described herein. For example, one or multiple rules based engines/programs can be used to perform the functions of pre-provisioning preparation system 20 by receiving, as input(s), order 30, order information, and/or device identification information, and using those inputs to generate outputs, which can be reformatted device identification information.

Pre-provisioning preparation system 20 can include multiple components for receiving order 30 from client 28, identify whether client 28 has a pre-provisioning profile 60, extracting device identification information from device 70, configuring the device identification information into reformatted device identification information suitable for upload to pre-provisioning center 26, and/or automatically uploading the reformatted device identification information to pre-provisioning center 28. Provisioning system 10 can include a configuration in which one, some, or all of these functions are performed by different components (such as hardware vendor 22, troubleshooting system 24, etc.). Preparation system 20 can include various components for performing the above functions (as well as other functions described in this disclosure), such as processor 44, memory 46, and/or user interface 48.

Pre-provisioning preparation system 20, (and/or other components of provisioning system 10 and/or preparation system 20, such as hardware vendor 22 and/or troubleshooting system 24) can include one or multiple computer processors 44 (also referred to as “processor 44”). In general, processor 44 can include any or more than one of a processor, a microprocessor, a controller, a digital signal processor (DSP), an application specific integrated circuit (ASIC), a field-programmable gate array (FPGA), or other equivalent discrete or integrated logic circuitry. Processor 44 can perform instructions stored within storage media, such as memory 46 (or located elsewhere), and/or processor 44 can include storage media such that processor 44 is able to store instructions and perform the functions described herein. Additionally, processor 44 can perform other computing processes described herein, such as the functions performed by any of the components of provisioning system 10 and/or preparation system 20.

Pre-provisioning preparation system 20 (and/or other components of provisioning system 10 and/or preparation system 20) can also include memory 46. Memory 46 is configured to store information and, in some examples, can be described as a computer-readable storage medium. Memory 46, in some examples, is described as computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, memory 46 is a temporary memory. As used herein, a temporary memory refers to a memory having a primary purpose that is not long-term storage. Memory 46, in some examples, is described as volatile memory. As used herein, a volatile memory refers to a memory that that the memory does not maintain stored contents when power to memory 46 is turned off. Examples of volatile memories can include random access memories (RAM), dynamic random-access memories (DRAM), static random access memories (SRAM), and other forms of volatile memories. In some examples, the memory is used to store program instructions for execution by the processor. The memory, in one example, is used by software or applications running on pre-provisioning preparation system 20 to temporarily store information during program execution.

Memory 46, in some examples, also includes one or more computer-readable storage media. Memory 46 can be configured to store larger amounts of information than volatile memory. Memory 46 can further be configured for long-term storage of information. In some examples, memory 46 includes non-volatile storage elements. Examples of such non-volatile storage elements can include, for example, magnetic hard discs, optical discs, floppy discs, flash memories, cloud storage (e.g., electronic storage media on a server or other media remote from the operator's computer hardware), or forms of electrically programmable memories (EPROM) or electrically erasable and programmable (EEPROM) memories. As shown in the example of pre-provisioning preparation system 20, memory 46 can store order information, shipping information, payment information, device identification information, reformatted device identification information, client information, information regarding whether client 28 has client pre-provisioning profile 60 at pre-provisioning center 26, and other information, data, and/or instructions.

Pre-provisioning preparation system 20 (and/or other components of system 10 and/or system 20) can also include user interface 48. User interface 48 can be an input and/or output device and enables an operator to control operation of pre-provisioning preparation system 20. For example, user interface 48 can be configured to receive inputs from an operator and/or provide outputs. User interface 48 can include one or more of a sound card, a video graphics card, a speaker, a display device (such as a liquid crystal display (LCD), a light emitting diode (LED) display, an organic light emitting diode (OLED) display, etc.), a touchscreen, a keyboard, a mouse, a joystick, or other type of device for facilitating input and/or output of information in a form understandable to users and/or machines.

Hardware vendor 22 can be incorporated into preparation system 20 (as shown in example FIG. 1B) so that both are in the same location and use processor 44, memory 46, and/or user interface 48 in conjunction as an all-encompassing component to perform the functions disclosed herein. Alternatively, hardware vendor 22 can be separate from preparation system 20 as shown in example FIG. 1A. For example, hardware vendor 22 can be a separate entity/company than that which includes pre-provisioning preparation system 20 and can have its own processor, memory, and/or user interface (among other components). In one example, hardware vendor 22 is a computer hardware device fulfillment center that include inventory having device 70 (and other computer hardware) with the fulfillment center being owned and/or operated by or in association with the same company/entity that owns and/or operates preparation system 20. In another example, hardware vendor 22 is a different company or separate entity potentially situated at a different location than pre-provisioning preparation system 20, and hardware vendor 22 is in wired or wireless communication with pre-provisioning preparation system 20 to exchange information regarding client 28 and/or device 70.

Hardware vendor 22 can include order reception module 40 configured to receive order 30 for deice 70 from client 28. In other examples, order reception module 40 can be part of pre-provisioning preparation system 20, and information regarding order 30 can be provided by pre-provisioning preparation system 20 to hardware vendor 22. Order reception module 40 can include or be in communication with a user interface that allows for client 28 to place order 30, such as a website on the internet. Order reception module 40 can be in communication with any of the components of system 10 and can include other capabilities and/or functions.

Hardware vendor 22 can also include extraction module 42. Extraction module 42 can be configured to associate device 70 with client 28 (among other capabilities). For example, device 70 can be within inventory and then removed from inventory to prepare device 70 for shipment to client 28. During this process, device 70 can be designated as being for client 28 to fulfill order 30. Extraction module 42 can also be configured to extract device identification information from device 70. The device identification information can be physically on device 70, physically on a package containing device 70, and/or digitally on or within device 70 (e.g., in the “properties” dialogue box on software on device 70). The device identification information can include a model number, a serial number, a maker/brand of device 70, a date that device 70 was constructed and/or assembled, a hardware identifier, and other information regarding device 70. Extraction module 42 can be configured to scan a barcode or other code that contains the device identification information, examine device 70 (and/or a package for device 70) and collect device identification information visually, such as through the use of computer vision and/or optical character recognition, and/or extract device identification information through other means. In one example, device identification information for device 70 is collected upon reception and/or construction of device 70 by hardware vendor 22 and is stored in memory 46 or at another location. Once order 30 is placed, extraction module 42 can associate device 70 with client 28 within an inventory software system and extract/access the device identification information as stored in memory 46 or at another location.

After extracting the device identification information, hardware vendor 22 can prepare device 70 (e.g., labeling and packing device 70) and send device 70 to client 28 via various means, including via shipping device 70.

Hardware vendor 22 can communicate the device identification information to pre-provisioning preparation system 20 (e.g., to memory 46 and/or configuration module 50). Configuration module 50 can access the device identification information in memory 46 and/or receive the device identification information from hardware vendor 22 and configure/transform the device identification information into reformatted device identification information that is in a format that is suitable for upload to and acceptance by pre-provisioning center 26. Configuring device identification information can include adding, modifying, and/or deleting digits, characters, and/or spaces within any numbers, words, phrases, etc. in device identification information. Configuring device identification information can also include adding information based on the device identification information, such as a maker/brand based on the device model number. Configuration module 50 can also change the type of file within which reformatted device identification information is contained and/or saved to a file format that is suitable for uploading to pre-provisioning center 26. Configuration module 50 can perform other manipulations of device identification information to allow for uploading and use by pre-provisioning center 26.

Pre-provisioning preparation system 20 can also include upload module 52, which is in wired or wireless communication with pre-provisioning center 26 to upload/send reformatted device identification information to pre-provisioning center 26. Upload module 52, and pre-provisioning preparation system 20 generally, can be configured to automatically upload the reformatted device identification information after configuration module 50 generates the reformatted device identification information. For example, preparation system 20 can automatically upload the reformatted device identification information when the reformatted device identification information is added or saved to memory 46. Upload module 52 can include other capabilities, functions, and/or configurations not disclosed herein for providing reformatted device identification information to pre-provisioning center 26. For example, upload module 52 can be configured to create device profile 64 to which the reformatted device identification information is sent/uploaded for use in provisioning device 70.

Pre-provisioning preparation system 20 can include other components and/or capabilities, such as identification module 54 configured to identify that client 28 has client pre-provisioning profile 60 such that preparation system 20 is aware that pre-provisioning needs to be performed on device 70 (so device identification information needs to be extracted, configured, and uploaded). Pre-provisioning preparation system 20 can include a record that includes clients 28 that each have a client pre-provisioning profile 60. Identification module 54 can be in communication with pre-provisioning center 26 to receive a notice/information regarding whether client 28 has a client pre-provisioning profile 60, or the notice/information regarding whether client 28 has a client pre-provisioning profile 60 can be received by pre-provisioning preparation system 20 and saved in record 21 or other matter in memory 46 for access by identification module 54. In one example, identification module 54 can compare client 28 that placed order 30 to record 21 of clients having a client pre-provisioning profile 60 to determine if client 28 has a pre-provisioning profile 60. Identification module 54 can perform the comparison and/or identification automatically after order 30 and/or device identification information are received (e.g., in response to receiving order 30 and/or device identification information), or identification module 54 can be prompted by a user/operator or other component and/or instruction. Record 21 can be stored in memory 46 or at another location and can include a list of clients 28 that have a pre-provisioning profile 60 in pre-provisioning center 26.

Pre-provisioning preparation system 20 (i.e., any of the components of pre-provisioning preparation system 20) can examine the device identification information, and can include alert module 56 that can prompt an alert in response to the device identification information have particular characteristics that may prevent configuration into reformatted device identification information that is suitable for upload. Alert module 56 can prompt the alert to troubleshooting system 24 to notify troubleshooting system 24 of the characteristics so that troubleshooting system 24 can review the device identification information. Additionally, troubleshooting system 24 can alter the characteristics (and/or instruct configuration module 50) to ensure the configuration of device identification information produces reformatted device identification information that is able to be uploaded and used by pre-provisioning center 26. Troubleshooting system 24 can be a part of preparation system 20 or can be a separate component, and troubleshooting system 24 can have a variety of configurations and/or capabilities. For example, troubleshooting system 24 can use processor 44, memory 46, and/or user interface 48 either as part of pre-provisioning preparation system 20 or as a separate component (or include its own processor(s), memory, etc.). Additionally, troubleshooting system 24 can have a user interface that allows a user/operator to manually correct/alter the device identification information. In another example, troubleshooting system 24 can automatically alter (or instruct configuration module 50 to correct/alter) the device identification information and/or use a rules-based engine/program to perform corrective tasks.

The issue or information that prompts an alert and/or notice by alert module 56 can be anything that may interfere with the extraction, configuration, and/or uploading of device identification information. In one example, alert module 56 prompts an alert in response to a model number of the device identification information showing that device 70 is a new model that has not previously been seen by pre-provisioning preparation system 20 and has not previously experienced the pre-provisioning preparation and/or provisioning process. In this situation, troubleshooting system 24 or another component of pre-provisioning preparation system 20 can reconfigure the model number of the device identification information into reformatted model number/device identification information that can be uploaded to pre-provisioning center 26. In another example, alert module 56 prompts an alert in response to a serial number of device identification information showing that the serial number is in a format that cannot be uploaded to pre-provisioning center 26. In this situation, troubleshooting system 24 or another component of pre-provisioning preparation system 20 can reconfigure the serial number of the device identification information into reformatted serial number (e.g., device identification information) that can be uploaded to pre-provisioning center 26.

Pre-provisioning preparation system 20 can also include notification module 58, which can be configured to notify various stakeholders regarding the status of device 70 and/or the pre-provisioning process. The stakeholders can include client 28; any individual and/or programs/components internal to pre-provisioning preparation system 20, such as hardware vendor 22; the individual to which device 70 is being sent, the individual that placed order 30, and/or any other individuals, entities, programs, etc. that is interested in receiving updates/notifications as to the status of the pre-provisioning and/or provisioning of device 70. Notification module 58 can update/notify the stakeholders regarding any statuses, changes in status, development/progression along the pre-provisioning and/or provisioning processes, and/or other information/data regarding device 70. For example, notification module 58 can provide a notice to the stakeholders upon pre-provisioning preparation system 20 receiving order 30. In another example, notification module 58 can provide a notice to the stakeholders upon extraction of device identification information from device 70. Another example can include notification module 57 providing the stakeholders with an update regarding the reformatting of the device identification information and/or the uploading of reformatted device identification information to pre-provisioning center 26. Other examples can include notification module 58 providing a notice to stakeholders when device 70 is sent to client 28, when device 70 is received by client 28, when device 70 is deployed, and/or when the provisioning of device 70 has begun and/or has been completed.

The above components of pre-provisioning preparation system 20, hardware vendor 22, and/or troubleshooting system 24 can each include or collectively use a computer processor having necessary software (e.g., processor 44), digital storage media (e.g., memory 46), a user interface (e.g., user interface 48), and/or other elements, hardware, software, etc. for performing the functions described herein.

Pre-provisioning preparation system 20 provides/uploads reformatted device identification information (and information that associates the reformatted device identification information to client 28) to pre-provisioning center 26, while pre-provisioning center 26 can provide information detailing that client 28 has a client pre-provisioning profile 60 to pre-provisioning preparation system 20.

Pre-provisioning center 26 can be a cloud-based management system, such as Microsoft Intune, and/or a system used to set up and pre-configure new devices, such as Windows Autopilot. In one example, pre-provisioning center 26 is one all-encompassing system that can include and/or perform the functions of both schemes. In another example, pre-provisioning center 26 is multiple components that collectively allow for client 28 to provide client information 32 to create client pre-provisioning profile 60 having previsioning configuration 62 and/or device profile 64 for specifying the client's preferences for provisioning device 70. Pre-provisioning center 26 can have any configurations, capabilities, and elements for performing the functions described herein. For example, pre-provisioning center 26 can have one or multiple computer processors, storage media/memory, user interfaces, and/or other components at one or multiple locations (e.g., in the cloud, at multiple data and/or processing centers, etc.).

Client 28, or preparation system 20, can set up client pre-provisioning profile 60 on/at pre-provisioning center 26. Client pre-provisioning profile 60 can include designated information dependent upon client information 32, and pre-provisioning system 20 and/or pre-provisioning center 26 can locate the provisioning preferences as designated in provisioning configuration 62 and/or device profile 64. Client 28 can create client pre-provisioning profile 60 (and provisioning configuration 62 and/or device profile 64) through various means, such as providing client information 32 via a website, a user portal, an email message, and/or other methods. In one example, client 28 can have the entity/company operating preparation system 20 create client pre-provisioning profile 60, provisioning configuration 62, and/or device profile 64 for client 28 by providing client information 32 to pre-provisioning center 26.

The preferences for the software, layouts, applications, configurations, etc. client 28 desires on device 70 (e.g., the provisioning of device 70) can be specified in provisioning configuration 62. The preferences set out in provisioning configuration 62 can be specified for device 70 specifically or can be generally specified depending on the type of hardware to be provisioned for client 28 (e.g., any PC ordered by client 28 will be provisioned according to a first configuration while any Chrome device ordered by client 28 will be provisioned according to a second configuration as set out in provisioning configuration 62). These preferences in provisioning configuration 62 can be set up, modified, and/or deleted at any time by client 28 and/or anyone with permission/access to client pre-provisioning profile 60.

The reformatted device identification information can be provided to and/or stored in device profile 64 of client pre-provisioning profile 60. With the reformatted device identification information being in device profile 64 to associate device 70 with client 28, pre-provisioning center 26 can determine how device 70 is to be provisioned. For example, reformatted device identification information can include that device 70 is a PC computer. Pre-provisioning center 26 can see this in device profile 64 and determine that, based on provisioning configuration 62, that device 70 is to be provisioned according to a first configuration. Thus, after device 70 is sent to client 28 from hardware vendor 22 and deployed (e.g., powered on and/or connected to the internet), pre-provisioning center 26 can automatically start provisioning device 70 based on the preferences set out by client 28 in provisioning configuration 62.

When device 70 is deployed, pre-provisioning center 26 can recognize device 70 via reformatted device identification information in device profile 64 and automatically begin provisioning device 70. To provision device 70, client 28 will have to take only minimal action, such as powering on device 70 and/or connecting device 70 to the internet (or otherwise place device 70 in communication with pre-provisioning center 26). Because pre-provisioning center 26 is provided information about device 70 (e.g., reformatted device identification information) by pre-provisioning preparation system 20, pre-provisioning center 26 can locate and/or recognize device 70 to automatically begin provisioning device 70.

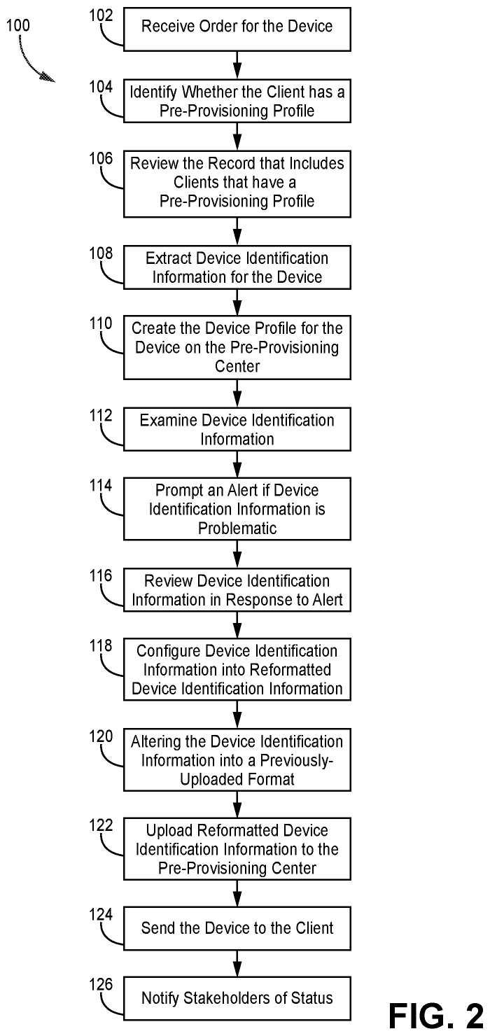

FIG. 2 is an example flow chart of pre-provisioning preparation process 100 as performed by, for example, preparation system 20 in FIGS. 1A and 1B. While process 100 is described herein as being used with regards to provisioning system 10 and/or preparation system 20, process 100 can be performed by any system having any components, capabilities, configurations, and/or functionalities suitable for performing process 100. Additionally, process 100 can include other steps not expressly disclosed herein and/or can include performing the disclosed steps in any order and/or multiple times as is desired and/or necessary to pre-provision device 70 for client 28.

First, process 100 includes step 102, which is to receive order 30 for device 70. Order 30 can be received from client 28 or another entity and can be received by pre-provisioning preparation system 20, hardware vendor 22, and/or by another component of provisioning system 10. Order 30 can be placed via any method, including via a phone call, in person, and/or through a website on the internet. Step 102 can include finding device 70 within inventory, such as within a warehouse full of computer hardware products, and/or can include associating the device 70 with client 28, such as by noting or otherwise marking on device 70 and/or within an inventory system that device 70 is earmarked for client 28 to fulfill order 30.

Then, process 100 can include step 104, which is to identify whether client 28 has a client pre-provisioning profile 60. Step 104 can include providing client information to pre-provisioning center 26 and pre-provisioning center 26 determining whether client 28 has a pre-provisioning profile 60. Alternatively, step 104 can include pre-provisioning preparation system 20 identifying whether client 28 has a pre-provisioning profile 60, such as by client 28 notifying preparation system 20 that client 28 has created a pre-provisioning profile 60. Step 104 can be performed and/or include other ways of identifying if client 28 has a client pre-provisioning profile 60, such as via step 106. Step 104 can be performed by any component of preparation system 20, including identification module 54.

Step 106 can include pre-provisioning preparation system 20 reviewing record 21, which can include a list of all clients 28 that have client pre-provisioning profile 60 in pre-provisioning center 26. Pre-provisioning center 26 can provide a client profile notice to pre-provisioning preparation system 20 (when a client pre-provisioning profile 60 is created for client 28) to create and/or add clients 28 to record 21, or pre-provisioning preparation system 20 can otherwise have information regarding if client 28 has a client pre-provisioning profile 60 (such as by client 28 notifying preparation system 20 that client 28 has created a pre-provisioning profile 60).

In response to step 104 and/or 106 revealing that client 28 has a pre-provisioning profile 60, process 100 may continue with step 108, which is to extract device identification information for device 70. The extraction of device identification information, as described above, can be performed by any of the components of preparation system 20, including hardware vendor 22 and/or extraction module 42. The device identification information can be extracted by physically examining device 70 and/or a package containing device 70 or by extracting the information digitally from device 70 (or by other methods). Step 108 can also include providing pre-provisioning preparation system 20 with the device identification information that is extracted from device 70.

Process 100 can also include step 110, which includes creating a device profile 64 for device 70 on pre-provisioning center 26 and associating device profile 64 with client pre-provisioning profile 60. Device profile 64 can be on client pre-provisioning profile 60 and can include provisioning configuration 62. Device profile 64 can include instructions for how device 70 is to be provisioned by pre-provisioning center 26 once device 70 is deployed by client 28. Step 110 can be performed by pre-provisioning preparation system 20, an operator in control of operation of preparation system 20, client 28, and/or by any other party authorized by client 28 to aid in the provisioning of device 70. Process 100 does not need to include step 110 if client pre-provisioning profile 60 already includes instructions and/or information for provisioning device 70.

Next, process 100 can include step 112, which is to examine device identification information. Step 112 can be performed by preparation system 20 and/or other components, such as troubleshooting system 24. Device identification information is examined to determine if the information correctly identifies device 70 and/or is in a format that may be suitable for configuration module 50 to configure the information.

If step 112 reveals that device identification information is problematic (e.g., does not correctly identify device 70 and/or is in an incorrect format), step 114 can be performed, which includes prompting an alert in response to device identification information being problematic. The alert can consist of any notice provided to an operator of preparation system 20 and/or to troubleshooting system 24. The alert can be prompted by preparation system 20 in response to the examination of the device identification information, or the alert can be prompted by another component/system, such as by alert module 56 or troubleshooting system 24 (in this example, troubleshooting system 24 would be provided with device identification information and perform steps 112 and 114).

In response to the performance of step 114 prompting the alert, process 100 can include step 116, which includes reviewing device identification information in response to the alert. The review can examine device identification information for errors that would prevent the uploading of the device identification information and/or prevent the performance of step 118 (configuring the information). Troubleshooting system 24 can review device identification information and alter device identification information as needed, or other components of system 20 can review and/or alter device identification information in response to an alert.

Next, process 100 can include step 118, which is configuring device identification information into reformatted device identification information. Step 118 can be performed by preparation system 20 and, more specifically, by configuration module 50. Step 118 can include adding, modifying, and/or deleting digits, characters, and/or spaces within any numbers, words, phrases, etc. in device identification information to reformat the information into reformatted device identification information that is suitable for upload to and acceptance by pre-provisioning center 26.

Step 120 can be performed anytime during process 100, which is altering the device identification information into a previously-uploaded format. Step 120 can be a subset of step 118 or can be performed at another time during process 100. Device identification information can be altered/configured into a format that has previously been uploaded to pre-provisioning center 26. For example, device 70 can be a specific type of computer hardware item that has previously been pre-provisioned by provisioning system 10, so preparation system 20 can recognize that device 70 is this specific type of computer hardware item and alter the device identification information into that format that was used/uploaded for the previous, similar computer hardware item and accepted by pre-provisioning center 26. Step 120 can be performed by any component of preparation system 20, including configuration module 50, and performed for any portion of device identification information, such as to the serial number, the model number, and/or the maker/brand identifier.

Process 100 can include step 122, which is uploading reformatted device identification information to pre-provisioning center 26. Preparation system 20 can upload the reformatted device identification information to pre-provisioning center 26 (e.g., to client pre-provisioning profile 60) by any method of communication, including wired or wireless communication, such as via the internet. Step 122 can include taking necessary security measures to ensure preparation 20 has access to pre-provisioning center 26 (and/or to client pre-provisioning profile 60), such as by entering a username and/or password or otherwise verifying/authenticating its permission to upload reformatted device identification information. Additionally, step 112 can include verification that the uploaded reformatted device identification information was successfully received and accepted by pre-provisioning center 26.

Process 100 can include step 124, which is sending/delivering device 70 to client 28. This can be performed by hardware vendor 22 or another component of provisioning system 10, and can include preparing device 70 for shipment and shipping device 70 to client 28. Once received by client 28, device 70 can be deployed and the provisioning of device 70 can be performed by pre-provisioning center 26.

Throughout pre-provisioning preparation process 100, process 100 can include step 126, which is notifying stakeholders of the status of device 70 and/or the status of the pre-provisioning of device 70. Step 126 can be performed by notification module 58 and/or by other components of pre-provisioning preparation system 20. Step 126 can be performed multiple times throughout process 100 and/or after any steps of process 100. The notification of stakeholders (step 126) can be performed after order 30 is received for device 70 (step 102), the device identification information is extracted for device 70 (step 108), device profile 64 is created for device 70 on pre-provisioning center 26 (step 110), the device identification information is configured into reformatted device identification information (step 118), the reformatted device identification information is uploaded to pre-provisioning center 26 (step 120), device 70 is sent to client 28 (step 124), and/or before, during, or after any of the other steps of process 100.

Provisioning system 10, preparation system 20, and related methods (e.g., process 100) are disclosed herein for use in pre-provisioning device 70 ordered by client 28 with software and/or configurations as specified by that client 28 dependent upon client 28 needs and/or preferences. Preparation system 20 can receive order 30 for device 70 as placed by client 28, identify that client 28 is one that has a client pre-provisioning profile 60 detailing provisioning configuration 62 for device 70, associate device 70 with client 28, and extract device identification information from device 70. The device identification information can then be configured into reformatted device identification information that is a format suitable for upload to (e.g., places the information in a format that is able to be accepted by) pre-provisioning center 26.

Pre-provisioning center 26 can include client pre-provisioning profile 60 and provisioning configuration 62 as specified by client 28. Preparation system 20 can automatically upload the reformatted device identification information to pre-provisioning center 26 and associate the reformatted device identification information with device profile 64 so that, when device 70 is deployed by client 28, pre-provisioning center 26 can connect to device 70 and provision device 70 with the client preferences specified in provisioning configuration 62. Without preparation system 20 uploading the reformatted device identification information for device 70 to associate device 70 with client 28, client 28 may be required to take multiple, complex steps to connect to pre-provisioning center 26, notify pre-provisioning center 26 of the particular device that needs to be provisioned, select the software and/or configuration to install onto device 70, and begin the provisioning process of device 70.

The following are nonlimiting examples of the systems and related processes of pre-provisioning a computer hardware device:

A method of pre-provisioning a computer hardware device for a client can include receiving an order for the device from the client, identifying whether the client has a pre-provisioning profile, in response to the client having a pre-provisioning profile, extracting device identification information for the device, configuring (by a computer processor) the device identification information into reformatted device identification information suitable for upload to a pre-provisioning center with the pre-provisioning center having the pre-provisioning profile for the client that designates a provisioning configuration for the device and configured to provision the device in response to a start-up prompt by the device, and uploading (by the computer processor), in response to the configurating of the device identification information into reformatted device identification information, the reformatted device identification information to the pre-provisioning center to link the device with the provisioning configuration of the client.

The method can further include that the step of identifying that the client has a pre-provisioning profile further includes reviewing a record that includes clients that have a pre-provisioning profile.

The method can further include examining the device identification information and prompting an alert in response to a model number of the device identification information showing that the device is a new model and has not previously experienced the pre-provisioning process.

The method can further include reviewing the device identification information in response to the alert.

The method can further include reconfiguring the model number of the device identification information into reformatted device identification information that can be uploaded to the pre-provisioning center.

The method can further include examining the device identification information and prompting an alert in response to a serial number of the device identification information showing that the serial number is in a format that cannot be uploaded to the pre-provisioning center.

The method can further include reconfiguring the serial number of the device identification information into reformatted device identification information that can be uploaded to the pre-provisioning center.

The method can further include that the device identification information includes at least one of the following: a model number of the device, a serial number of the device, and a hardware identifier.

The method can further include notifying stakeholders of a status of the device.

The method can further include that the steps of associating the device with the client and extracting the device identification information for the device are performed during preparation of the device for shipment to the client.

The method can further include uploading the reformatted device identification information to a device profile for the device on the pre-provisioning center.

The method can further include creating the device profile for the device on the pre-provisioning center to which the reformatted device identification information is uploaded.

The method can further include that the steps of extracting the device identification information and configuring the device identification information into reformatted device identification information are performed automatically by the computer processor in response to receiving the order for the device from the client and identifying that the client has a pre-provisioning profile.

The method can further include that the step of configuring the device identification information into reformatted device identification information further includes altering the device identification information into a format that has previously been uploaded to the pre-provisioning center for another, previous device.

A system for pre-provisioning preparation for a computer hardware device for a client can include an order reception module configured to receive an order for the device from the client, an identification module that reviews the order by the client and determines whether the client has a pre-provisioning profile, an extraction module in communication with the order reception module and configured to, in response to the identification module determining that the client has a pre-provisioning profile, extract device identification information for the device, a configuration module in communication with the extraction module and configured to reformat the device identification information into reformatted device identification information suitable for upload to a pre-provisioning center having the pre-provisioning profile for the client that designates a provisioning configuration for the device and being configured to provision the device in response to a start-up prompt by the device, and an upload module in communication with the configuration module and configured to upload, in response to the configurating of the device identification information into reformatted device identification information, the reformatted device identification information to the pre-provisioning center to link the device with the provisioning configuration of the client.

The system can further include that the configuration module and the upload module are at least partially incorporated into a first computer processor.

The system can further include that the order reception module and the extraction module are at least partially incorporated into a second computer processor in communication with the first computer processor.

The system can further include an alert module that is configured to prompt an alert in response to a model number of the device identification information showing that the device is a new model and has not previously experienced a pre-provisioning process.

The system can further include a record that includes clients that have a pre-provisioning profile, wherein the identification module reviews the order by the client and the record to determine whether the client is in the record and thus has a pre-provisioning profile.

The system can further include that, in response to the identification module determining that the client has a pre-provisioning profile, the extraction module extracts the device identification information, the configuration module reformats the device identification information into the reformatted device identification information, and the upload module automatically uploads the reformatted device identification information to the pre-provisioning center.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of pre-provisioning a computer hardware device for a client, the method comprising:
receiving an order for the device from the client;
identifying whether the client has a pre-provisioning profile;
in response to the client having a pre-provisioning profile, extracting device identification information for the device;
configuring, by a computer processor, the device identification information into reformatted device identification information suitable for upload to a pre-provisioning center, the pre-provisioning center having the pre-provisioning profile for the client that designates a provisioning configuration for the device and configured to provision the device in response to a start-up prompt by the device; and
uploading, by the computer processor and in response to the configurating of the device identification information into reformatted device identification information, the reformatted device identification information to the pre-provisioning center to link the device with the provisioning configuration of the client.

2. The method of claim 1, wherein the step of identifying that the client has a pre-provisioning profile further comprises:
reviewing a record that includes clients that have a pre-provisioning profile.

3. The method of claim 1, further comprising:
examining the device identification information; and
prompting an alert in response to a model number of the device identification information showing that the device is a new model and has not previously experienced the pre-provisioning process.

4. The method of claim 3, further comprising:
reviewing the device identification information in response to the alert.

5. The method of claim 4, further comprising:
reconfiguring the model number of the device identification information into reformatted device identification information that can be uploaded to the pre-provisioning center.

6. The method of claim 1, further comprising:
examining the device identification information; and
prompting an alert in response to a serial number of the device identification information showing that the serial number is in a format that cannot be uploaded to the pre-provisioning center.

7. The method of claim 6, further comprising:
reconfiguring the serial number of the device identification information into reformatted device identification information that can be uploaded to the pre-provisioning center.

8. The method of claim 1, wherein the device identification information includes at least one of the following: a model number of the device, a serial number of the device, and a hardware identifier.

9. The method of claim 1, further comprising:
notifying stakeholders of a status of the device.

10. The method of claim 1, wherein the steps of associating the device with the client and extracting the device identification information for the device are performed during preparation of the device for shipment to the client.

11. The method of claim 1, further comprising:
uploading the reformatted device identification information to a device profile for the device on the pre-provisioning center.

12. The method of claim 11, further comprising:
creating the device profile for the device on the pre-provisioning center to which the reformatted device identification information is uploaded.

13. The method of claim 1, wherein the steps of extracting the device identification information and configuring the device identification information into reformatted device identification information are performed automatically by the computer processor in response to receiving the order for the device from the client and identifying that the client has a pre-provisioning profile.

14. The method of claim 1, wherein the step of configuring the device identification information into reformatted device identification information further comprises:
altering the device identification information into a format that has previously been uploaded to the pre-provisioning center for another, previous device.

15. A system for pre-provisioning preparation for a computer hardware device for a client, the system comprising:
an order reception module configured to receive an order for the device from the client;
an identification module that reviews the order by the client and determines whether the client has a pre-provisioning profile;
an extraction module in communication with the order reception module and configured to, in response to the identification module determining that the client has a pre-provisioning profile, extract device identification information for the device;
a configuration module in communication with the extraction module and configured to reformat the device identification information into reformatted device identification information suitable for upload to a pre-provisioning center having the pre-provisioning profile for the client that designates a provisioning configuration for the device and being configured to provision the device in response to a start-up prompt by the device; and
an upload module in communication with the configuration module and configured to upload, in response to the configurating of the device identification information into reformatted device identification information, the reformatted device identification information to the pre-provisioning center to link the device with the provisioning configuration of the client.

16. The system of claim 15, wherein the configuration module and the upload module are at least partially incorporated into a first computer processor.

17. The system of claim 16, wherein the order reception module and the extraction module are at least partially incorporated into a second computer processor in communication with the first computer processor.

18. The system of claim 15, further comprising:
an alert module that is configured to prompt an alert in response to a model number of the device identification information showing that the device is a new model and has not previously experienced a pre-provisioning process.

19. The system of claim 15, further comprising:
a record that includes clients that have a pre-provisioning profile, wherein the identification module reviews the order by the client and the record to determine whether the client is in the record and thus has a pre-provisioning profile.

20. The system of claim 20, wherein, in response to the identification module determining that the client has a pre-provisioning profile, the extraction module extracts the device identification information, the configuration module reformats the device identification information into the reformatted device identification information, and the upload module automatically uploads the reformatted device identification information to the pre-provisioning center.
